(19) United States
(12) Patent Application Publication
(10) Pub. No.: US 2024/0308194 A1
(43) Pub. Date: Sep. 19, 2024

(54) MULTILAYER RUBBER HOSE

(71) Applicant: ContiTech USA, Inc., Fairlawn, OH (US)

(72) Inventors: Eric Dupont, Sherbrooke (CA); Vincent Rigaut, Montreal (CA); Véronique Romo, Granby (CA); Marie-Josee Brisson, St-Césaire (CA)

(21) Appl. No.: 18/263,840

(22) PCT Filed: Jan. 27, 2022
(86) PCT No.: PCT/US2022/070372

§ 371 Date: Aug. 1, 2023

Related U.S. Application Data
(60) Provisional application No. 63/144,065, filed on Feb. 1, 2021.

(51) Int. Cl. B32B 27/32; B32B 5/24; B32B 25/08; B32B 25/14; B32B 27/12

(52) U.S. Cl. CPC B32B 27/32; B32B 5/24; B32B 25/08; B32B 25/14; B32B 27/12; B32B 2250/03; B32B 2305/08; B32B 2305/18; B32B 2597/00

(57) ABSTRACT

A hose including an inner tube, a reinforcement layer disposed outwardly from the inner tube, and a cover layer disposed outwardly from the reinforcement layer, in which the hose meets requirements of NSF/ANSI/CAN 61 standard, and in some aspects, at least the inner tube is devoid of nitrosamines. In some cases, the inner tube includes ultra-high molecular weight polyethylene. In some other aspects, the inner tube includes other thermoplastic material. In some cases, the cover layer is based on a rubber material. Also, the hose may contain water within a lumen defined inside the inner walls of the inner tube.

### FIELD

The field to which the disclosure generally relates to hoses and particularly to high performance, reinforced hoses which are useful in a wide variety of applications. More specifically, the present invention relates to reinforced hoses which are NSF/ANSI/CAN 61 certified multilayer rubber hoses.

### BACKGROUND

This section provides background information to facilitate a better understanding of the various aspects of the disclosure. It should be understood that the statements in this section of this document are to be read in this light, and not as admissions of prior art.

Thermoplastic and rubber hoses are used in a variety of applications for transporting fluids such as liquids and gases. For example, multilayer thermoplastic and rubber hoses have been used for a long time in the aqueduct repair market as temporary replacement to aqueduct pipes. NSF/ANSI/CAN 61 certification of such hoses is now required in almost all U.S. states and Canadian provinces and territories. Some hoses that are NSF/ANSI/CAN 61 certified, for example, are extruded PVC products, and often, such products do not always meet the application requirements, especially in cold climates. The existing PVC hoses have limited low temperature abilities and are also somewhat stiff materials to be used for the type of hoses required for such application. Their low temperature inabilities and their relative stiffness have shorted the life expectancy of such products, especially in cold climate. Finally, the extrusion process used to make such hoses limits the size and the type of hose products that can be produced for this application.

Hence, there is an ongoing need for multilayer thermoplastic and rubber hoses meeting the NSF/ANSI/CAN 61 certification while provided requisite performance properties, particularly in cold climates. Such need is met, at least in part, with embodiments according to this disclosure.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration or amount or value range listed or described as being useful, suitable, or the like, is intended that any and every concentration or amount or value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Rubber compounds used in multilayer thermoplastic and rubber hoses often contain nitrosamine generating accelerators. When nitrosamines are generated during rubber cure, they may later permeate through the layers of the hose wall and leach into drinking water. Therefore, the main difficulty for a multilayer thermoplastic and rubber hose is to meet the very low nitrosamines concentration criteria established in NSF/ANSI/CAN 61 Standard, which is included herein by reference thereto. Hoses according to the disclosure are multilayer thermoplastic and rubber hoses that meeting NSF/ANSI/CAN 61 certification requirements.

Hose embodiments according to the disclosure are formed with materials which are generally free of nitrosamines and/or do not form nitrosamines in the hose manufacturing process. In other words, the materials are essentially, neither a direct source nor precursor (i.e., morpholine) of nitrosamines. Also, the hose embodiments are multilayer thermoplastic and rubber products which are more flexible, can be used at lower temperatures, and are available in larger sizes and in different type of hose constructions (soft wall, wire helix reinforced, monofilament reinforced) which allows for more versatility. Due to all these characteristics and the fact that they have been used for such application for a long time before the implementation of NSF/ANSI/CAN 61 standard, they have also been proven to be more durable.

Some hose embodiments according to the disclosure include, at least, cover layer, inner tube and reinforcing layer disposed between the cover layer and inner tube. Generally, the inner tube is formed of a thermoplastic barrier, such as, but not limited to, ultra-high molecular weight polyethylene (UHMWPE), and the outer tube and cover layer, or other optional layers, may be formed from any suitable curable rubbery compound, or compounds, which results in a hose which is sufficiently free of nitrosamines and other contaminants while meeting the NSF/ANSI/CAN 61 standard. Also, the reinforcing layer, or layers, may be formed of any suitable reinforcement material which results in a hose which is sufficiently free of nitrosamines and other contaminants while meeting the NSF/ANSI/CAN 61 standard.

According to one aspect of the disclosure the material forming the inner tubular layer is a NSF61 certified thermoplastic UHMWPE compound that is a barrier to many rubber chemicals that could likely otherwise, permeate into water to cause failure to comply with NSF61 standard. According to some other aspects, the material forming the inner tube filler includes a blend of a natural rubber and a styrene-butadiene copolymer rubber. In some cases, these are blended in a ratio of from 10% to 90% by weight of styrene-butadiene copolymer rubber and 10% to 90% by weight of natural rubber. Such a blend may further include pigments and/or dyes to provide a color and additives, such as fillers, processing aid, antioxidants, lubricants, cure accelerator and the like, added in any suitable amounts. The cure package is typically composed of sulfur, and thiurams accelerator were not used to avoid formation nitrosamine. Sulfonamides accelerators were used. In some aspects the inner tube is formed of a tube and a tube filler, and these are referred to herein as the “inner tube”, whenever used.

According to some aspects of the disclosure, the material used for forming the covering layer includes a compound of an ethylene propylene diene monomer rubber. This compound may further include pigments and/or dyes to provide a color and additives, such as fillers, processing aids, antioxidants, lubricants, cure accelerators, and the like, and in any suitable amounts. In one aspect, cure package is composed of sulfur and accelerator type selected from the group of accelerators which are generally free of nitrosamines and/or do not form nitrosamines in the hose manufacturing process.

Some non-limiting examples of cure accelerators useful in hose embodiments according to the disclosure, include, but are not limited to, 2-mercaptobenzothiazole (MBT), 2-2′-Dithiobis(benzothiazole) (MBTS), tetrabenzylthiuram disulfide (TBzTD), N-cyclohexyl-2-benzothiazole sulfenamide (CBS), N-tert-butyl-2-benzothiazole sulfenamide (TBBS), N,N′-dicyclohexyl-2-benzothiazole sulfenamide (DCBS), diphenyl guanidine (DPG), N, N′-diorthotolyl Guanidine (DOTG), zinc dibenzyl dithiocarbamate (ZBEC), N, N-captolactam disulfide (DTDC), ethylene thiourea (ETU), diethylene thiourea (DETU), diphenyl thiourea (DPTU), di-n-butyl thiourea (DBTU), zinc-O—,O-di-N-butylphosporodithioate (ZBPD), hexamethylene tetramine (HMT), dicumyl peroxide (DCP), tert-butyl cumyl peroxide (TBCP), di-tert-butyl peroxide (DTBP), dibenzoyl peroxide (DBP), tert-butyl peroxybenzoate (TBPB), and the like. In some embodiments, 2-2′-dithiobis(benzothiazole), tetrabenzylthiuram disulfide, N-cyclohexyl-2-benzothiazole sulfonamide, N,N′-dicyclohexyl-2-benzothiazole sulfonamide, and/or zinc dibenzyl dithiocarbamate are particularly useful.

The reinforcing layer included the hose embodiments of the disclosure, is not particularly limited, but like the reinforcing layer of a conventional hose may be one or more layers of a yarn produced from a vinylon fiber, rayon fiber, hemp fiber, polyester fiber, polyvinyl acetate fiber, nylon fiber, aramid fiber, natural fiber, etc. or a metal wire or metal alloy wire etc. braided, wrapped in a spiral, or wrapped in a plurality of spiraled layers wound in counter directions. In some other aspects, the reinforcement layer may be formed from sustainable materials.

According to some aspects of the disclosure, the reinforcement used in the reinforcing layer has rubber calendered thereon, resulting in a so-called calendered reinforcement layer. While any suitable rubber may be used, in some cases such rubber is a blend of a natural rubber, a styrene-butadiene copolymer rubber and an ethylene propylene diene monomer rubber, which may be blended in any suitable ratio. In one non-limiting example, these were blended in a ratio of about 29% of styrene-butadiene copolymer rubber, about 24% of natural rubber and about 47% of ethylene propylene diene monomer rubber, for example. Any suitable calendering rubber mixture may further include pigments and/or dyes to provide a color and additives, such as fillers, processing aids, antioxidants, lubricants, cure accelerators and the like, in any suitable amounts. In one non-limiting example, the cure package is composed of sulfur and sulfonamide accelerators.

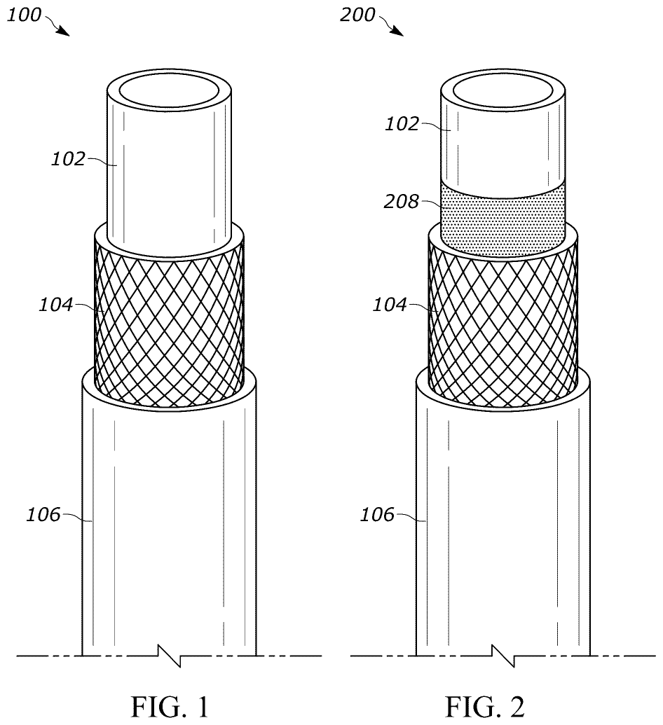

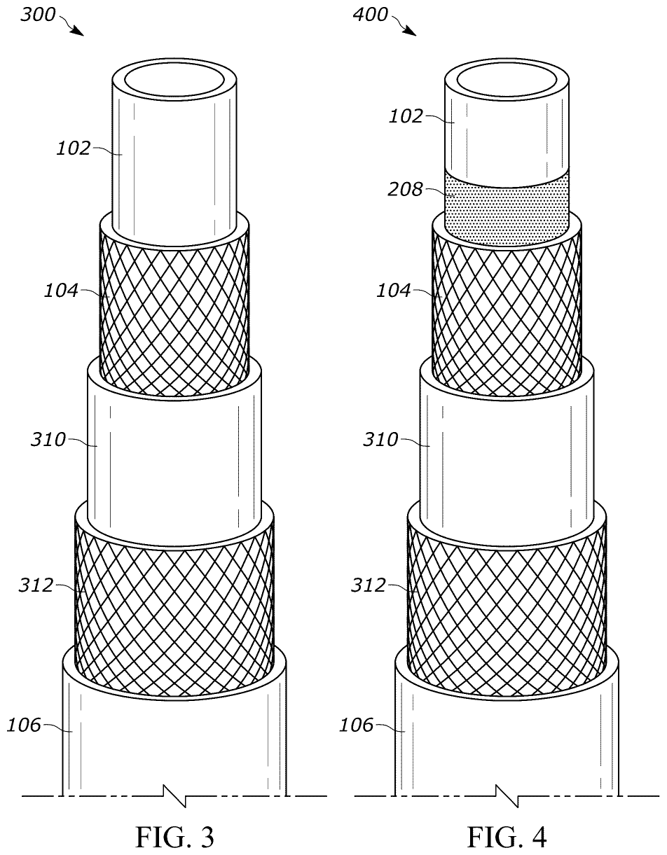

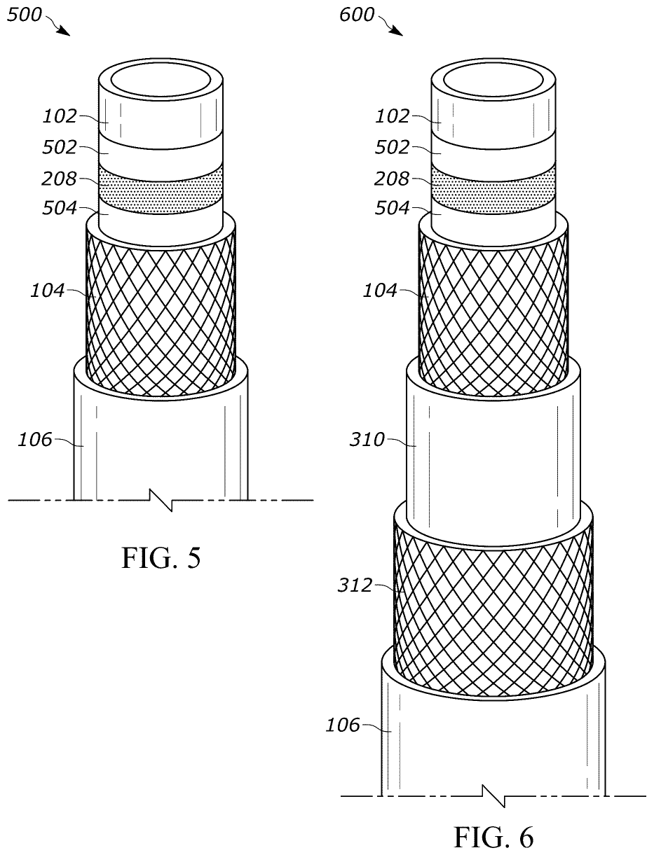

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein. FIG. 1 illustrates in perspective view, a hose according to some aspects of the disclosure, while FIG. 2 depicts in perspective view, another hose according to some aspects of the disclosure. FIG. 3 illustrates in perspective view, yet another hose according to some aspects of the disclosure, and FIG. 4 depicts in perspective view, another hose according to some aspects of the disclosure. FIG. 5 illustrates in perspective view, yet another hose according to some aspects of the disclosure, while FIG. 6 depicts in perspective view, another hose according to some aspects of the disclosure.

Some hose embodiments according to the disclosure have the structure shown in FIG. 1. The hose 100 is composed of at least an inner tube 102, reinforcing layer 104, and outer cover layer 106. In some aspects, the outer cover layer 106 and the inner tube 102 are formed from any of the materials described above. The materials useful in forming the inner tube 102 and/or cover layer 106 may be admixed with from about 50 to about 700 phr, of fillers such as carbon black, calcium carbonate, talc, clay or hydrated silica, or mixtures of the foregoing. Other optional conventional additives, process and extender oils, antioxidants, waxes, pigments, plasticizers, softeners and the like may be added according to common rubber processing practice without departing from the disclosure. For example, in some non-limiting embodiments, the rubber composition also contains from about 0.5 to about 1.5 phr of an antiozonant or antioxidant and from about 10 phr to about 200 phr of a paraffinic oil and/or naphthenic oil plasticizer/softener. Also, in some embodiments, the amount of carbon black is from about 200 phr to about 400 phr, and the amount of calcium carbonate is from about 150 phr to about 350 phr.

In one embodiment, hose 100 includes a tube and tube filler combined as inner tube 102 and the reinforcing layer 104 was constructed of two individual calendered fabric layers.

Further, in the production of some hoses according to the disclosure, it is possible to produce the inner tube 102 by known extrusion processes, provide an optional bonding layer or reinforcement on its outer surface if necessary, braid/spiral the reinforcing layer 104 over the same, and cover the same with the outer cover 106 by extrusion so as to bond the layers of the hose integrally. The hoses may then be cured.

In another aspect of the disclosure, some hose embodiments have the structure shown in FIG. 2. The hose 200 includes an inner tube 102, reinforcing layer 104, outer cover 106, similar to hose 100 described above, and further includes layer 208, which may be a ply reinforcement layer, or a bonding layer, or backing layer, or barrier layer, and layer 208 is disposed between inner tube 102 and reinforcing layer 104. When used as a ply reinforcement layer, it is not particularly limited, but may be produced from a vinylon fiber, rayon fiber, polyester fiber, nylon fiber, fiber from sustainable material, or aramid fiber, etc. in a ply configuration. When used as a barrier layer, it is not particularly limited, but may be produced from polyamide, PVDF, THV, and the like.

In yet another aspect of the disclosure, some hose embodiments have the structure shown in FIG. 3. The hose 300 includes an inner tube 102, reinforcing layer 104, friction layer 310, second reinforcing layer 312, and outer cover 106. The second reinforcing layer 312, is not particularly limited, but may be produced from one or more of a vinylon fiber, rayon fiber, polyester fiber, nylon fiber, aromatic polyamide fiber, fiber from sustainable material, etc. or a hard steel wire etc. braided, wrapped in a spiral, or wrapped in a plurality of spiraled layers wound in counter directions.

In one embodiment, hose 300 includes a tube and tube filler combined as inner tube 102, reinforcing layer 104 constructed of two individual calendered fabric layers, layer 310 as a filler layer, and second reinforcing layer 312 constructed of a polyester monofilament helix and two individual calendered fabric layers. In another embodiment, hose 300 includes a tube and tube filler combined as inner tube 102, reinforcing layer 104 constructed of an individual calendered fabric layer and a wire helix, and a further individual calendered fabric layer as second reinforcing layer 312.

In some other aspects of the disclosure, hose embodiments have the structure shown in FIG. 4. Hose 400 includes an inner tube 102, reinforcing layer 104, friction layer 310, second reinforcing layer 312, and outer cover 106. The hose further includes an optional layer 208 disposed between inner tube 102 and reinforcing layer 104.

With regards to the reinforcing layers 104, friction layers 310, second reinforcing layers 312, outer covers 106, and ply reinforcement layers depicted above, such may be formed from any suitable materials know to those of skill in the art. In some aspects, such layers may be formed from those materials disclosed in U.S. Pat. No. 6,179,008 B1, which is incorporated herein by reference thereto.

Now referencing FIG. 5 which depicts some other hose embodiments according to the disclosure. Hose 500 includes an inner tube 102, reinforcing layer 104, outer cover 106, layer 208, which may be a ply reinforcement layer, or a bonding layer, or backing layer, or barrier layer, similar to hose 200 described above. Disposed between inner tube 102 and layer 208 is a friction layer 502. Also, disposed between layer 208 and reinforcing layer 104 is friction layer 504. With reference to FIG. 6, hose 600 is similar to hose 500, and further includes friction layer 310 and second reinforcing layer 312 disposed between reinforcing layer 104 and outer cover 106, as shown.

In some cases, each of the reinforcing layers may be formed by spiral winding one or more layers of a yarn or hard steel wire. Reinforcing layers may also be formed from braid or knit reinforcements. In some cases where two layers of a yarn, metal wire, or metal alloy wire may be used, a first layer may be spiral wound in a first winding direction, and a second layer spiral wound in a second winding direction opposite the first winding direction. In some cases, the first layer is laid at a positive angle relative to the longitudinal axis of the hose, and the second layer laid at a negative angle relative to the longitudinal axis. The angle of one of layers may be between about 45° and 65°, and the angle of the other layers between about −45° and −65°.

The optional friction layer used in embodiments according to the disclosure is typically from about 0.020 inches (0.5 mm) to about 0.051 inches (1.3 mm) thick, is more typically from about 0.024 inches (0.6 mm) to about 0.043 inches (1.1 mm) thick, and in some aspects, will be from about 0.028 inches (0.7 mm) to about 0.035 inches (0.9 mm) in thickness. The friction layer may be formed from any suitable curable rubber based composition, containing such rubber as EPDM/EPR sustainable polymer, acrylonitrile butadiene rubber (NBR), hydrogenated NBR, carboxylated NBR, polychloroprene, fluoroelastomer, epichlorohydrin, nitrile, carboxylated nitrile rubber, CPE, CSM, styrene-butadiene rubber (SBR), NBR/PVC blends, or any blends thereof.

Referring again to cover layers, in some embodiments according to the disclosure, cover layers have a thickness of from about 0.039 inches (1 mm) to about 0.12 inches (3 mm), from about 0.059 inches (1.5 mm) to about 0.098 inches (2.5 mm), and in some instances, about 0.067 inches (1.7 mm) to about 0.075 inches (1.9 mm). The thickness of the inner tube in some embodiments according to the disclosure, may be from about 0.031 inches (0.8 mm) to about 0.157 inches (4 mm), and in some instances, from about 0.039 inches (1.0 mm) to about 0.138 inches (3.5 mm). In some embodiments, the hose outer diameter may be from about 0.5 inches (12 mm) to about 5 inches (127 mm).

One example was prepared for the purpose of further illustrating the nature of some of the embodiments and aspects of the disclosure and are not intended as a limitation on the scope thereof. In this example, the hose was prepared from materials described in the following tables:

TABLE 1
Inner tube (filler tube/filler rubber layer)

| | | Non-Productive | Productive |
|---|---|---|---|
| | | 1st stage | 2nd stage |
| INGREDIENT | Ratio | PHR | PHR |
| Zinc oxide - Activator | 1.8 | 3.00 | 2.37 |
| Calcium Carbonate - filler | 9.0 | | 26.06 |
| Styrene-butadiene copolymer rubber | 23.1 | | 67.23 |
| Kaolin - Filler | 29.2 | | 84.94 |
| Sulfur | 0.8 | | 2.40 |
| Silica | 10.2 | | 29.56 |
| Pigment | 1.9 | | 5.48 |
| DCBS - Sulfenamides accelerator | 0.8 | | 2.20 |
| Antioxydant | 0.7 | | 2.00 |
| Process aid | 0.4 | | 1.25 |
| Styrene-butadiene copolymer rubber | 9.5 | | 27.62 |
| Natural rubber | 34.3 | 100.00 | |
| Antioxidant | 2.6 | | 7.50 |
| Pigment | 3.8 | | 10.98 |
| Accelerator - Stearic acid | 0.9 | | 2.50 |
| Process oil | 2.1 | | 6.00 |
| Non-productive 1st stage | 4.5 | | 13.06 |
| Total | | 103.00 | 291.15 |

TABLE 2
Rubber calendered onto reinforcement fabric

| | | Non-Productive | |
|---|---|---|---|
| | Ratio | 1st stage | |
| INGREDIENT | (%) | PHR | 2nd stage |
| Zinc oxide - Activator | 1.6 | 3.00 | 2.13 |
| Calcium Carbonate - filler | 4.2 | | 13.64 |
| Styrene-butadiene copolymer | 11.4 | | 36.55 |
| rubber | | | |
| Kaolin - Filler | 36.4 | | 116.75 |
| Sulfur | 0.8 | | 2.50 |
| Silica | 7.5 | | 24.00 |
| Pigment - Titanium dioxide | 1.2 | | 3.93 |
| Tackifier - Polyol ester rosin | 3.1 | | 10.00 |
| based | | | |
| Ethylene propylene diene | 18.7 | | 60.00 |
| monomer rubber | | | |
| CBS - Sulfenamide accelerator | 0.6 | | 1.89 |
| Process aid | 0.6 | | 2.00 |
| Aliphatic resin | 1.2 | | 4.00 |
| Natural rubber | 31.1 | 100.00 | |
| Stabilizer - Octamine | 0.3 | | 1.00 |
| Accelerator - Stearic acid | 0.8 | | 2.50 |
| Process oil | 2.7 | | 8.74 |
| Pigment | 0.4 | | 1.42 |
| Non-Productive 1st stage | 9.4 | | 30.04 |
| Total | | 103.00 | 321.09 |

TABLE 3
Cover rubber layer

| | | Productive |
|---|---|---|
| | | 1st stage |
| INGREDIENT | Ratio (%) | PHR |
| Ethylene propylene diene monomer | 24.2 | 100.00 |
| rubber | | |
| Silica | 3.9 | 16.26 |
| Carbon black | 0.2 | 0.94 |
| Kaolin - Filler | 15.9 | 65.90 |
| Kaolin - Filler | 32.0 | 132.05 |
| Process oil | 8.5 | 34.96 |
| Accelerator - Stearic acid | 0.6 | 2.50 |
| Zinc oxide - Activator | 1.2 | 5.00 |
| Process aid | 0.4 | 1.77 |
| Process aid | 0.5 | 2.01 |
| Pigment - Titanium dioxide | 1.4 | 5.99 |
| Pigment | 0.5 | 2.01 |
| Pigment | 1.7 | 7.14 |
| Process aid | 0.2 | 0.97 |
| Process oil/Plasticizer | 7.2 | 29.93 |
| Sulfur | 0.5 | 2.02 |
| MBTS - Thiazole accelerator | 0.6 | 2.50 |
| ZBED - Dithiocarbamates accelerator | 0.2 | 0.91 |
| Total | | 413.28 |

Cured samples of the above materials were tested in accordance with the NSF/ANSI/CAN 61 standard. All materials tested meet the requirements of NSF/ANSI/CAN 61 and were also free of nitrosamine. The test report, reference as J-00370077, is incorporated herein by reference thereto, and is available from www.nsf.org.

Some hose embodiments according to the disclosure have dimensions, performance ratings and weight as given in Table 4. The values in Table 4 are examples, but hoses according to the disclosure are not necessarily limited thereto.

TABLE 4

| Inner | | Outer | | Water Pressure | | Weight/ | |
|---|---|---|---|---|---|---|---|
| Diameter | | Diameter | | Rating | | Unit Length | |
| (in) | (mm) | (in) | (mm) | (PSI) | (MPa) | (Lb/ft) | (Kg/m) |
| 0.75 | 19.1 | 1.264 | 32.1 | 200 | 1.38 | 0.53 | 0.792 |
| 1 | 25.4 | 1.52 | 38.6 | 200 | 1.38 | 0.69 | 1.026 |
| 1.25 | 31.8 | 1.768 | 44.9 | 200 | 1.38 | 0.82 | 1.226 |
| 1.5 | 38.1 | 2.016 | 51.2 | 200 | 1.38 | 0.96 | 1.427 |
| 2 | 50.8 | 2.531 | 64.3 | 200 | 1.38 | 1.25 | 1.854 |
| 2.5 | 63.5 | 3.063 | 77.8 | 200 | 1.38 | 1.67 | 2.481 |
| 3 | 76.2 | 3.61 | 91.7 | 200 | 1.38 | 2.15 | 3.197 |
| 4 | 101.6 | 4.622 | 117.4 | 200 | 1.38 | 2.82 | 4.202 |
| 0.75 | 19.1 | 1.094 | 27.8 | 150 | 1.03 | 0.3 | 0.44 |
| 1 | 25.4 | 1.346 | 34.2 | 150 | 1.03 | 0.38 | 0.559 |
| 1.25 | 31.8 | 1.594 | 40.5 | 150 | 1.03 | 0.46 | 0.677 |
| 1.5 | 38.1 | 1.846 | 46.9 | 150 | 1.03 | 0.53 | 0.795 |
| 2 | 50.8 | 2.362 | 60 | 150 | 1.03 | 0.73 | 1.086 |
| 2.5 | 63.5 | 2.862 | 72.7 | 150 | 1.03 | 0.9 | 1.333 |
| 3 | 76.2 | 3.386 | 86 | 150 | 1.03 | 1.15 | 1.71 |
| 4 | 101.6 | 4.386 | 111.4 | 150 | 1.03 | 1.51 | 2.243 |
| 2 | 50.8 | 2.58 | 65.5 | 200 | 1.38 | 1.23 | 1.825 |
| 3 | 76.2 | 3.795 | 96.4 | 200 | 1.38 | 2.52 | 3.744 |
| 4 | 101.6 | 4.835 | 122.8 | 200 | 1.38 | 3.42 | 5.091 |

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

### LIST OF REFERENCE NUMERALS (PART OF THE SPECIFICATION)

100 Hose
102 Inner tube
104 Reinforcing layer
106 Cover layer
108 Sprocket tooth space
200 Hose
208 Ply reinforcement, bonding layer, backing, or barrier layer
300 Hose
310 Friction of filling layer
312 Second reinforcing layer
400 Hose
500 Hose
502 Friction layer
504 Friction layer
600 Hose

1. A hose comprising an inner tube, a reinforcement layer disposed outwardly from the inner tube, and a cover layer disposed outwardly from the reinforcement layer, wherein at least the inner tube is devoid of nitrosamines and the hose meets requirements of NSF/ANSI/CAN 61 standard.

2. (canceled)

3. (canceled)

4. The hose according to claim 1, materials forming one or more of the inner tube, the reinforcement layer and/or the cover layer comprise one or more accelerator(s) selected from the group consisting of 2-mercaptobenzothiazole (MBT), 2-2′-Dithiobis(benzothiazole) (MBTS), tetrabenzylthiuram disulfide (TBzTD), N-cyclohexyl-2-benzothiazole sulfenamide (CBS), N-tert-butyl-2-benzothiazole sulfenamide (TBBS), N,N′-dicyclohexyl-2-benzothiazole sulfenamide (DCBS), diphenyl guanidine (DPG), N, N′-diorthotolyl Guanidine (DOTG), zinc dibenzyl dithiocarbamate (ZBEC), N, N-captolactam disulfide (DTDC), ethylene thiourea (ETU), diethylene thiourea (DETU), diphenyl thiourea (DPTU), di-n-butyl thiourea (DBTU), zinc-O—,O-di-N-butylphosporodithioate (ZBPD), hexamethylene tetramine (HMT), dicumyl peroxide (DCP), tert-butyl cumyl peroxide (TBCP), di-tert-butyl peroxide (DTBP), dibenzoyl peroxide (DBP), and tert-butyl peroxybenzoate (TBPB).

5. The hose according to claim 1, wherein materials forming one or more of the inner tube, the reinforcement layer and/or the cover layer comprise one or more accelerator(s) selected from the group consisting of 2-2′-dithiobis(benzothiazole), tetrabenzylthiuram disulfide, N-cyclohexyl-2-benzothiazole sulfonamide, N,N′-dicyclohexyl-2-benzothiazole sulfonamide, and zinc dibenzyl dithiocarbamate.

6. The hose according to claim 1, wherein the inner tube comprises a tube and tube filler.

7. The hose according to claim 1, wherein the reinforcing layer comprises two individual calendered fabric layers.

8. The hose according to claim 1 further comprising a friction layer and a second reinforcing layer, wherein the inner tube comprises a tube and tube filler.

9. The hose according to claim 8, wherein the reinforcing layer comprises two individual calendered fabric layers, and wherein the second reinforcing layer comprises a polyester monofilament helix and two individual calendered fabric layers.

10. The hose according to claim 8, wherein the reinforcing layer comprises an individual calendered fabric layer and a wire helix layer, and wherein the second reinforcing layer comprises a second individual calendered fabric layer.

11. The hose according to claim 1, wherein the inner tube comprises ultra-high molecular weight polyethylene.

12. The hose according to claim 1, wherein the inner tube comprises a thermoplastic material.

13. The hose according to claim 1, wherein the cover layer comprises a rubber material, the inner tube comprises a thermoplastic material, and the reinforcement layer comprises fiber.

14. The hose according to claim 1, wherein the inner tube comprises a rubber material.

15. The hose according to claim 1 further comprising water in a lumen formed inside the inner tube.

16. The hose according to claim 1, wherein materials forming one or more of the inner tube, the reinforcement layer and/or the cover layer comprise one or more accelerator(s) including sulfonamide accelerator(s).

17. The hose according to claim 6, wherein the tube is formed of a thermoplastic barrier, and the tube filler is formed of a rubber.

18. The hose according to claim 13, wherein the thermoplastic material of the inner tube includes ultra-high molecular weight polyethylene, and the rubber material of the cover layer includes ethylene propylene diene monomer rubber.

19. The hose according to claim 1, wherein all layers of the hose are devoid of nitrosamines.

20. A hose comprising an inner tube, a reinforcement layer disposed outwardly from the inner tube, and a cover layer disposed outwardly from the reinforcement layer, wherein materials forming one or more of the inner tube, the reinforcement layer and/or the cover layer comprise one or more accelerator(s) selected from the group consisting of 2-2′-dithiobis(benzothiazole), tetrabenzylthiuram disulfide, N-cyclohexyl-2-benzothiazole sulfonamide, N,N′-dicyclohexyl-2-benzothiazole sulfonamide, and zinc dibenzyl dithiocarbamate, and wherein at least the inner tube is devoid of nitrosamines.

21. The hose according to claim 20, wherein the cover layer comprises a rubber material, the inner tube comprises a thermoplastic material, and the reinforcement layer comprises fiber.

22. A hose comprising an inner tube, a reinforcement layer disposed outwardly from the inner tube, and a cover layer disposed outwardly from the reinforcement layer, wherein:
the inner tube comprises a tube and a tube filler,
the tube comprising a thermoplastic barrier,
the tube filler comprising a rubber,
the reinforcement layer comprising a calendered rubber-fabric layer, and
the cover layer comprising a rubber that is different than the rubber of the tube filler,
wherein each of the inner tube, the reinforcement layer, and the cover layer is free of nitrosamines.
